(19) United States
(12) Patent Application Publication
(10) Pub. No.: US 2013/0212317 A1
(43) Pub. Date: Aug. 15, 2013

(54) Storage and Host Devices for Overlapping Storage Areas for a Hibernation File and Cached Data

(71) Applicants: Shai Traister, Sunnyvale, CA (US); Rizwan Ahmed, San Jose, CA (US)

(72) Inventors: Shai Traister, Sunnyvale, CA (US); Rizwan Ahmed, San Jose, CA (US)

(21) Appl. No.: 13/371,980

(22) Filed: Feb. 13, 2012

(51) Int. Cl. G06F 12/08; G06F 12/00

(52) U.S. Cl. 711/103; 711/135; 711/E12.008; 711/E12.022

(57) ABSTRACT

Storage and host devices are provided for overlapping storage areas for a hibernation file and cached data. In one embodiment, a storage device is provided that receives a command from a host device to evict cached data in a first address range of the memory. The storage device then receives a command from the host device to store a hibernation file in a second address range of the memory, wherein the second address range does not exist in the memory. The storage device maps the second address range to the first address range and stores the hibernation file in the first address range. In another embodiment, a host device is provided that sends a command to a first storage device to evict cached data in a first address range of the first storage device's memory. The host device then sends a command to the first storage device to store a hibernation file in the first address range.

### BACKGROUND

A power-savings option for personal computers and other computing devices is to put the device in hibernation mode. When the device is set to hibernation mode, the data from the device's volatile RAM is saved to non-volatile storage as a hibernation file. With the hibernation file saved, the device does not need to power the volatile RAM and other components, thus conserving battery life of the device. When the computing device exits hibernation mode, the stored hibernation file is retrieved from non-volatile storage and copied back to the device's RAM, thus restoring the device to the state it was in prior to hibernation.

### Overview

Embodiments of the present invention are defined by the claims, and nothing in this section should be taken as a limitation on those claims.

By way of introduction, the below embodiments relate to storage and host devices for overlapping storage areas for a hibernation file and cached data. In one embodiment, a storage device is provided that receives a command from a host device to evict cached data in a first address range of the memory. The storage device then receives a command from the host device to store a hibernation file in a second address range of the memory, wherein the second address range does not exist in the memory. The storage device maps the second address range to the first address range and stores the hibernation file in the first address range. In another embodiment, a host device is provided that sends a command to a first storage device to evict cached data in a first address range of the first storage device's memory. The host device then sends a command to the first storage device to store a hibernation file in the first address range.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary host device and storage device of an embodiment.

FIG. 2 is an illustration of a mapping process of an embodiment, in which a 4 GB hibernation partition and a 16 GB caching partition are mapped into a single 16 GB physical space.

FIG. 3 is an illustration of a mapping process of an embodiment for a caching operation.

FIG. 4 is an illustration of a hibernation process of an embodiment.

FIG. 5 is an illustration of a resume process of an embodiment.

FIG. 6 is an illustration of an alternative to a hibernation process of an embodiment.

FIG. 7 is an illustration of an alternative to a resume process of an embodiment.

### DETAILED DESCRIPTION OF THE PRESENTLY PREFERRED EMBODIMENTS

### General Introduction

By way of introduction, some of the below embodiments can be used to make a solid-state drive appear to a host device as having both a dedicated partition for a hibernation file and a separate dedicated partition for cached data even though it, in fact, has only a single partition for cached data. This is accomplished by over-provisioning the solid-state drive and exposing a larger capacity to the host device (e.g., a 16 GB solid-state drive will be seen by the host device as having 20 GB). When a hibernation event occurs, a caching module on the host device evicts cached data in the solid-state drive to make room for the hibernation file. A hibernation module on the host device then copies a hibernation file to the solid-state drive. However, as the hibernation module is not aware of the smaller capacity of the solid-state drive, it may be attempting to write the hibernation file to an address range that does not exist on the solid-state drive. Accordingly, a controller in the solid-state drive can map the “extra” logical block address (LBA) space that the host device thinks exists onto a range within the physical space of the solid-state drive that actually exists, thereby overlapping the hibernation area with the caching area. (Since the data was evicted, even though the address space overlaps, no data loss actually occurred.) When the hibernation mode is exited, the hibernation module requests the hibernation file from the non-existent address range. The solid-state drive maps the address to the real address and returns the hibernation file to the host device (the mapping can occur before entering hibernation mode and also when exiting hibernation mode). As the hibernation file in the solid-state drive is no longer needed after the data from the file is restored in the host drive's memory, the caching module can repurposed that space by repopulating the cache to its full capacity.

In another embodiment, both the caching module and the hibernation module on the host device are aware of the space limitations of the solid-state drive, so the hibernation module can provide suitable addresses to the solid-state drive. This avoids the need for the solid-state drive to perform address translation on “out of range” addresses.

### Exemplary Embodiments

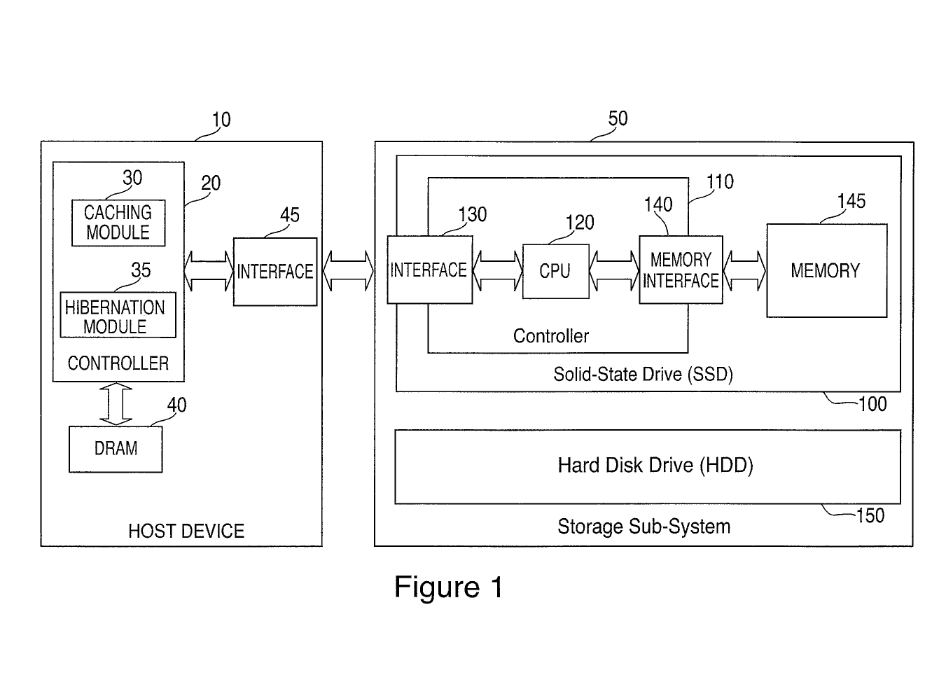

Turning now to the drawings, FIG. 1 is a block diagram of a host device 10 in communication with a storage sub-system 50, which, in this embodiment, contains a solid-state drive (SSD) 100 and a hard-disk drive (HDD) 150. As used herein, the phrase “in communication with” could mean directly in communication with or indirectly in communication with through one or more components, which may or may not be shown or described herein. For example, the host device 10 and solid-state drive 100 and/or the hard-disk drive (HDD) 150 can each have mating physical connectors (interfaces) that allow those components to be connected to each other. Although shown as separate boxes in FIG. 1, the solid-state drive 100 and the hard-disk drive do not need to be two separate physical devices, as they could be combined together into a “hybrid hard drive” in which the solid-state drive resides within the hard disk drive. The solid-state drive can then directly communicate to the host device through a dedicated connector, or only communicate to the hard disk drive controller through an internal bus interface. In the latter case, the host device can communicate to the solid-state drive through the hard disk drive controller.

In this embodiment, the host device 10 takes the form of a personal computer, such as an ultrabook. The host device 10 can take any other suitable form, such as, but not limited to, a mobile phone, a digital media player, a game device, a personal digital assistant (PDA), a kiosk, a set-top box, a TV system, a book reader, a medical device, or any combination thereof.

As shown in FIG. 1, the host device 10 contains a controller 20, which implements a caching module 30 and a hibernation module 35. In one embodiment, the controller 20 contains a CPU that runs computer-readable program code (stored as software or firmware in the controller 20 or elsewhere on the host device 10) in order to implement the caching module 30 and the hibernation module 35. Use of these modules will be described in more detail below. The controller 20 is in communication with volatile memory, such as DRAM 40, which stores data used in the operation of the host device 10. The controller 20 is also in communication with an interface 45, which provides a connection to the storage sub-system 50. The host device 10 can contain other components (e.g., a display device, a speaker, a headphone jack, a video output connection, etc.), which are not shown in FIG. 1 to simplify the drawing.

As noted above, the storage sub-system 50 contains both a solid-state drive 100 and a hard disk drive 150 (or a hybrid hard drive, as noted above). The solid-state drive 100 contains a controller 110 having a CPU 120. The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Examples of controllers include, but are not limited to, the following microcontrollers: ARC 625D, Atmel AT91SAM, Microchip PIC18F26K20, and Silicon Labs C8051F320. The controller 110 also has an interface 130 to the host device 10 and a memory interface 140 to a solid-state (e.g., flash, 3D, BICS, MRAM, RRAM, PCM and others) memory device 145. The solid-state drive 100 can contain other components (e.g., a crypto-engine, additional memory, etc.), which are not shown in FIG. 1 to simplify the drawing. In one embodiment, the hard disk drive 150 takes the form of a conventional magnetic disk drive, the particulars of which are not shown in FIG. 1 to simplify the drawing.

To illustrate this embodiment, consider the situation in which the host device 10 is a personal computer, such as an ultrabook, and the solid-state drive 100 and the hard disk drive 150 are internal (or external) drives of the computer. (In one embodiment, the solid-state drive 100 is embedded in the motherboard of the computer 10.) In this example, the hard disk drive 150 has a larger capacity than the solid-state drive 50 (e.g., 320 GB vs. 16 GB). In operation, the larger-capacity hard disk drive 150 is used as conventional data storage in the computer, and the smaller-capacity solid state drive 100 is used to cache frequently-accessed data to reduce the amount of time needed to retrieve or store the data from the storage sub-system (because the solid-state drive 100 has a faster access time than the hard disk drive 150). The caching module 30 on the computer/host device 10 is responsible for moving data into and out of the solid-state drive 100, as needed.

In addition to caching, this “dual drive” system can be used in conjunction with a hibernation mode. As discussed above, hibernation mode (also referred to as the “S4 state”) is a power-savings option for personal computers and other computing devices, in which data from the device's volatile RAM is saved to non-volatile storage as a hibernation file. With the hibernation file saved, the device 10 does not need to power the volatile DRAM 40, thus conserving battery life of the device 10. When the device 10 exits hibernation mode, the stored hibernation file is retrieved from non-volatile storage and copied back to the device's DRAM 40, restoring the device to the state it was in prior to hibernation. With the use of a dual drive SSD/HDD storage subsystem, 50, the hibernation file is preferably stored in the solid-state drive 100, as the faster access time of the solid-state drive 100 allows the device 10 to exit hibernation mode faster.

The hibernation module 35 of the host device 10 is responsible for storing and retrieving the hibernation file. The hibernation module 35 can also perform other activities relating to the hibernation process. For example, the hibernation module 35 can work with the host's BIOS to enable a smooth transition from a system standby mode (the “S3 mode”) to the hibernation mode (the “S4 mode”) using a timer, and can perform compression on the data to be stored in the hibernation file. Examples of a hibernation module 35 include Intel's Smart Response Technology (SRT) and Intel's Fast Flash Storage (iFFS) software. Of course, these are only examples, and the hibernation module can take other forms.

One issue that can arise in the use of a dual-drive system is that the requirements for data caching may be in conflict with the requirements for hibernation. For example, Intel's 2012 ultrabook requirements specify that the minimum caching partition (i.e., the size of the solid-state drive 100) has to be at least 16 GB. The requirements also specify a dedicated partition (e.g., an iFFS partition) in the solid-state drive 100 of 4 GB (or 2 GB) to store the hibernation file (e.g., an iFFS file), so the computer can exit the hibernation mode in seven seconds or less. Accordingly, these two requirements result in the need for the solid-state drive to have a capability of 20 GB. However, many solid-state drives today are sold either as 16 GB drives or 24 GB drives. While a 24 GB drive will meet the requirements, it may not be a cost-effective solution.

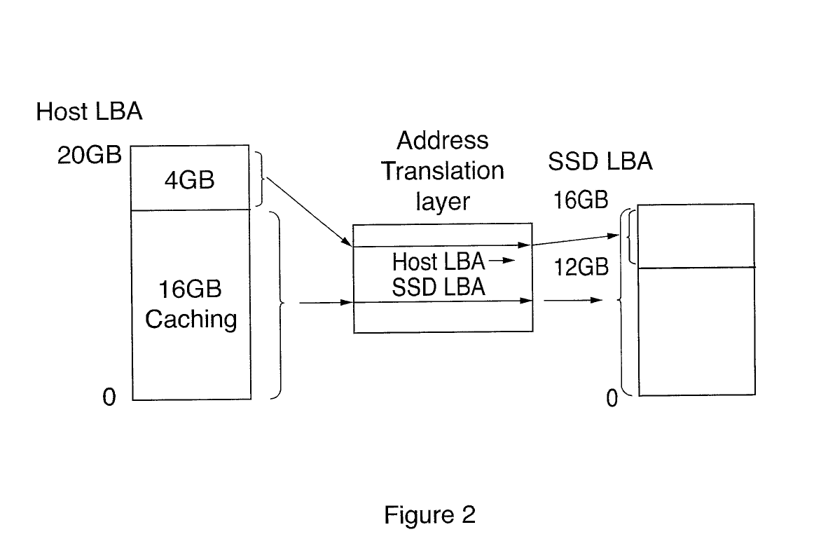

To address this problem, in one embodiment, the controller 110 of the solid-state drive 100 maps the 4 GB hibernation partition and the 16 GB caching partition into a single 16 GB physical space partition. (4 GB and 16 GB are merely examples, and it should be understood that these embodiments can be applied to other sizes.) This embodiment takes advantage of the fact that the hibernation file and the cached data are not used at the same time. That is, when the hibernation file is stored when the host device 10 is in hibernation mode; thus, the host device 10 would not be requesting cached data. Likewise, cached data would be requested when the host device 10 is active and not in hibernation mode; thus, a hibernation file would not be needed. This embodiment will now be described in more detail in conjunction with FIGS. 2-7.

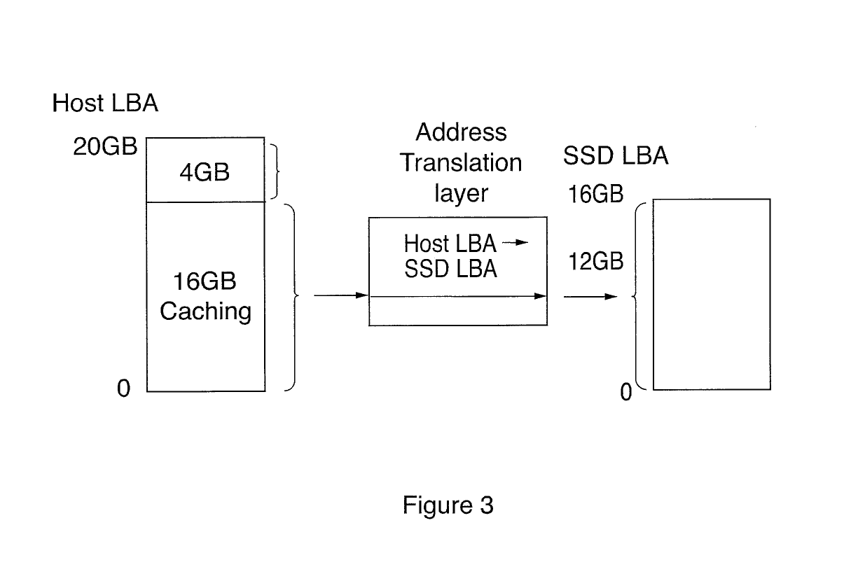

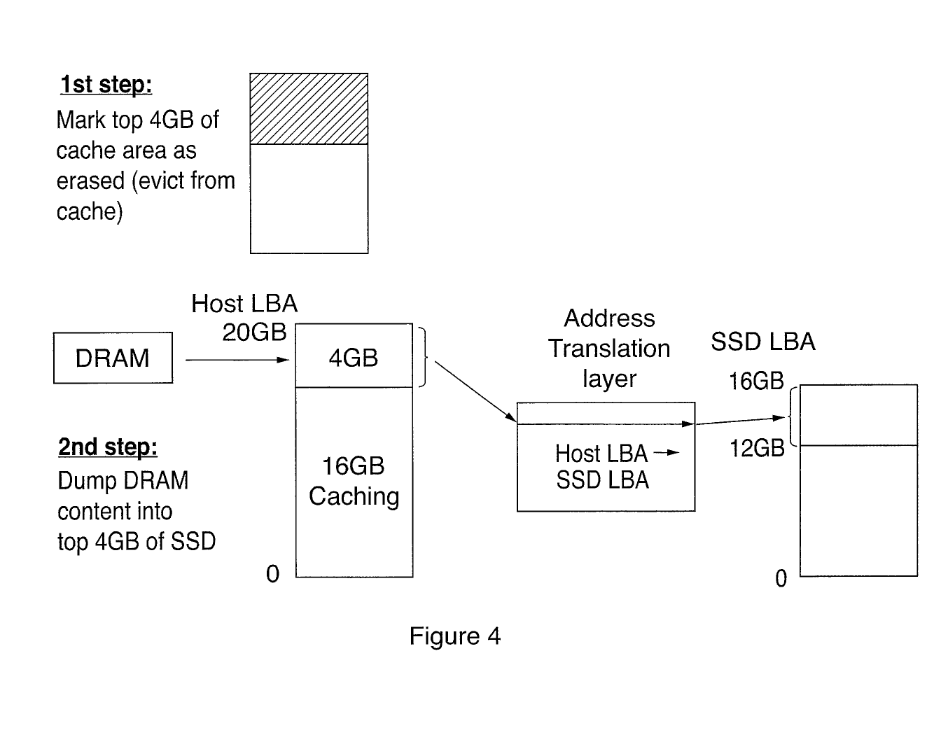

As shown in FIG. 2, the host device defines a 20 GB logical block address (LBA) range, with 16 GB allocated for caching and 4 GB allocated for a hibernation file. The controller 110 of the solid-state drive 100 runs software/firmware to implement an address translation layer that translates the host LBAs to LBAs used by the solid-state drive 100 (the controller 110 can then translate the solid-state drive's LBA to physical addresses of the memory 145). Alternatively, the address translation layer can be implemented in hardware. As shown by the two brackets on the right-hand side of the figure, this translation results in mapping the 4 GB hibernation partition and the 16 GB caching partition into a single 16 GB physical space. As the mapping shown in FIG. 2 results in an overlap of the hibernation file and cached data (shown as the 12 GB-16 GB range in FIG. 2), steps can be taken to maintain data coherency in the overlapped area, which will now be described in conjunction with FIGS. 3 and 4.

FIG. 3 illustrates the mapping process of the caching operation. As discussed above, the caching module 30 on the host device 10 is responsible for maintaining the cached data on the solid-state drive 100. This can involve, for example, determining what data from the hard disk drive 150 should be copied to the solid-state drive 100, when such data should be evicted (or marked as evicted) from the cache on the solid-state drive, when the cache (or hard disk drive) should be updated (e.g., depending on whether the cache is operating in a copy-back mode or a copy-through mode), etc. As illustrated in FIG. 3, in a normal caching operation, the 16 GB LBA range as seen by the host device 10 translates to the 16 GB LBA range as seen by the solid-state drive 100.

FIG. 4 illustrates the process that occurs when the host device 10 enters hibernation mode. In this embodiment, the caching module 30 is aware that the solid-state drive 100 only has 16 GB, whereas the hibernation module 35 believes that the solid-state drive 100 has 20 GB. As shown in the “1^{st} Step” in FIG. 4, when the host device 10 enters hibernation mode, the caching module 30 marks the “top” 4 GB of the cached area on the solid-state drive 100 as erased. (While “top” is being used in this example, it should be understood that this is merely an example, and the claims should not be limited to this example.) That is, the caching module 30 evicts (or marks as evicted) the data in the top 4 GB of the cached area (i.e., the 12 GB-16 GB LBA range), thereby making room for the 4 GB hibernation file. Next, the hibernation module 35 creates the hibernation file and stores it in the solid-state drive 100 (as mentioned above, the hibernation module 35 can perform related functions, such as working with the host's BIOS to enable a smooth transition from a system standby mode (the “S3 mode”) to the hibernation mode (the “S4 mode”) using a timer and can perform compression on the data to be stored in the hibernation file). In this embodiment, while the caching module 30 is aware that the solid-state drive 100 only has a single 16 GB partition, the hibernation module 35 is not. Therefore, as shown in FIG. 4, the hibernation module 35 sends a request to the solid-state drive 100 to store the hibernation file in the 16 GB-20 GB LBA range, which the hibernation module 35 thinks exists on the solid-state drive 100 but, in fact, does not. When the controller 110 of the solid-state drive receives this request, it translates the 16 GB-20 GB LBA range to the 12 GB-16 GB LBA range, which was previously evicted by the caching module 30, and stores the hibernation file in that area.

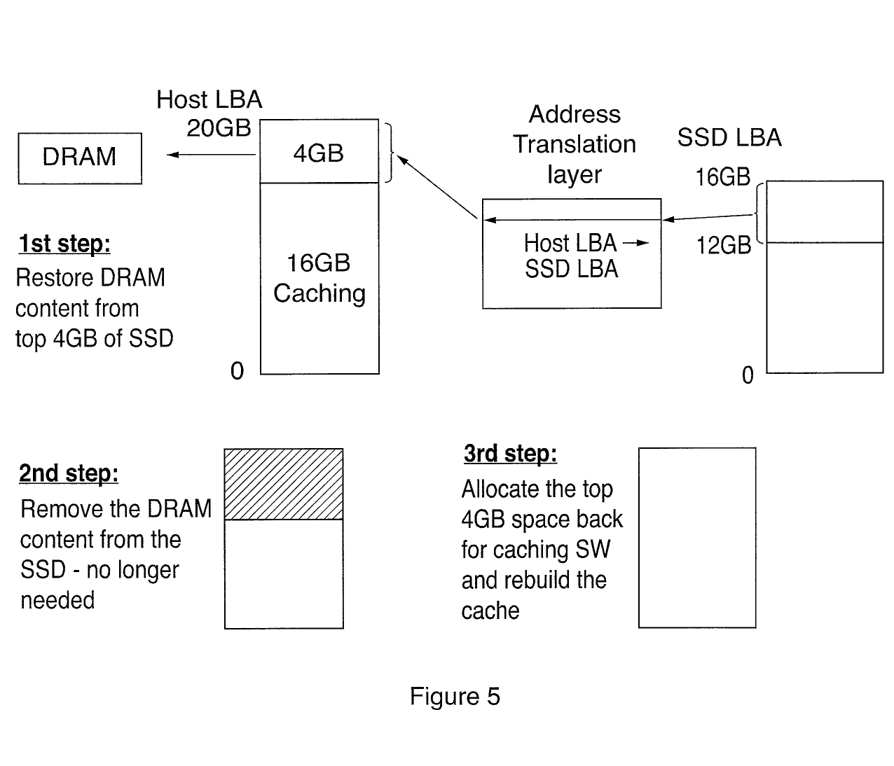

FIG. 5 illustrates the process that occurs when the host device 10 exits hibernation mode. As illustrated by the “1^{st} step” portion of the drawing, the hibernation module 35 sends a request to the solid-state drive 100 to read the hibernation file at the 16 GB-20 GB LBA range, which does not exist. When the controller 110 of the solid-state drive receives this request, it translates the 16 GB-20 GB LBA range to the 12 GB-16 GB LBA range and provides the hibernation file stored therein back to the host device 10, which stores it in DRAM 40. With the hibernation file restored to DRAM 40, there is no need for the solid-state drive 100 to store the hibernation file, as it takes up storage space that would otherwise be used for caching. Accordingly, the caching module 30 evicts the hibernation file from the 12 GB-16 GB LBA range of solid-state drive 100 (“2^{nd} step”). This 12 GB-16 GB LBA range is then allocated back to the caching module 30 to rebuild the cache by copying files from the hard disk drive 150 into this area (“3^{rd} step”) or storing new data sent from the host device 10.

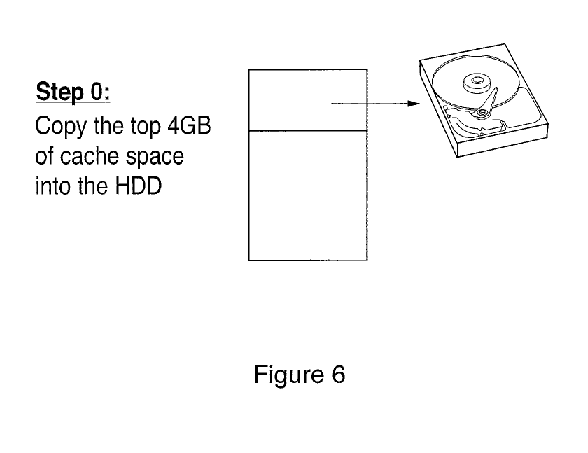

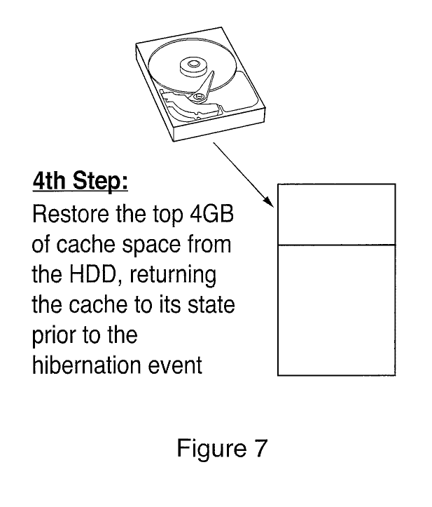

As mentioned above, after the host device 10 resumes from a hibernation event, the caching module 30 rebuilds the “overlapped” 4 GB cache that was evicted to make room for the hibernation file. It is possible that this process of rebuilding the cache can result in lower cache hit rates immediately after hibernation events in the periods in which the cache is rebuilt. In order to avoid this, prior to the hibernation event, the caching module 30 can copy the 4 GB of cached data from the 12 GB-16 GB LBA range of the solid-state drive 100 into the hard disk drive 150 prior to de-populating or evicting it from the cache. (When a hybrid hard drive is used, the solid-state drive can send the copy directly to the hard disk drive instead of sending the copy to the host device for it to store in the hard disk drive.) This is shown as “Step 0” in FIG. 6 (“Step 0” would occur before the “1^{st} Step” in FIG. 4). Then, after the wakeup process is complete and the hibernation file is no longer needed, the caching module 30 can copy the cache data from the hard disk drive 150 back to the 12 GB-16 GB LBA range of the solid-state drive 100, thereby restoring the cache to the state it was in prior to the hibernation event. This is shown as the “4^{th} Step” in FIG. 7 (the “4^{th} Step” would occur after the “3^{rd} Step” in FIG. 5). While this alternative can prolong the process of entering into the hibernation mode because of the time needed to copy the 4 GB of cached data to the hard disk drive 150, this can be done while the host device 10 is already in standby mode, so as to not be noticeable to end users. Also, while copying back the stored data into the cache can prolong the process of waking up from hibernation mode, such copying back does not need to happen immediately and can wait for an appropriate time when the solid-state drive 100 is idle and thus not impact the user experience. This way, there will be only a negligible impact to the cache hit ratio in the short time that it takes to complete this process.

In the above embodiment, the caching module 30 was aware of the space limitations of the solid-state drive 100 but the hibernation module 35 was not so aware. Thus, the controller 110 in the solid-state drive 100 was used to translate address ranges provided by the hibernation module. In another embodiment, both the caching module and the hibernation module are aware of the space limitations of the solid-state drive, so the hibernation module can provide suitable addresses to the solid-state drive. This avoids the need for the solid-state drive to perform address translation on “out of range” addresses. So, in the example set forth above, after the caching module evicts 4 GB of data from the cache, the hibernation module would send a request to the solid-state drive to store the hibernation file in the 12 GB-16 GB LBA range, instead of the non-existent 16 GB-20 GB address range. Additionally, this “aware” hibernation module can perform some or all of the other activities that the “unaware” hibernation module described above performed (e.g., working with the host's BIOS to enable a smooth transition from a system standby mode (the “S3 mode”) to the hibernation mode (the “S4 mode”) using a timer, performing compression on the data to be stored in the hibernation file, etc.). In one particular implementation, Intel's Smart Response Technology (SRT) or iFFS software is modified to be aware of the capacity limitations of the solid-state drive and perform the above processes.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A storage device comprising:
a memory; and
a controller in communication with the memory, wherein the controller is configured to:
receive a command from the host device to evict cached data in a first address range of the memory;
receive a command from the host device to store a hibernation file in a second address range of the memory, wherein the second address range does not exist in the memory;
map the second address range to the first address range; and
store the hibernation file in the first address range.

2. The storage device of claim 1, wherein the controller is further configured to:
receive a command from the host device to retrieve the hibernation file from the second address range of the memory;
map the second address range to the first address range;
retrieve the hibernation file from the first address range; and
send the hibernation file to the host device.

3. The storage device of claim 2, wherein the controller is further configured to perform the following after sending the hibernation file to the host device:
receive data to be stored in the first address range to repopulate the cache; and
store the received data in the first address range.

4. The storage device of claim 1, wherein the controller is further configured to, prior to evicting the cached data, sending the cached data to the host device to be stored in a second storage device.

5. The storage device of claim 1, wherein the controller is further configured to, prior to evicting the cached data, sending the cached data to a second storage device for storage.

6. The storage device of claim 5, wherein the storage device is a solid-state drive, wherein the second storage device is a hard disk drive, and wherein the solid-state drive and the hard disk drive are part of a hybrid hard drive.

7. The storage device of claim 1, wherein the command to evict the cached data is received from a caching module of the host device, and wherein the command to store the hibernation file is received from a hibernation module of the host device.

8. The storage device of claim 1, wherein the storage device is a solid-state drive, which, along with a hard disk drive, serves as a storage sub-system to the host device.

9. The storage device of claim 8, wherein the solid-state drive and the hard disk drive are part of a hybrid hard drive.

10. A host device comprising:
one or more interfaces through which to communication with first and second storage devices;
volatile memory; and
a controller in communication with the one or more interfaces and the volatile memory, wherein the controller is configured to perform the following in response to a request to enter into a hibernation mode:
create a hibernation file from data stored in the volatile memory;
send a command to the first storage device to evict cached data in a first address range of the first storage device's memory; and
send a command to the first storage device to store the hibernation file in the first address range of the first storage device's memory.

11. The host device of claim 10, wherein the controller is further configured to:
send a command to the first storage device to retrieve the hibernation file from the first address range of the first storage device's memory; and
store the hibernation file in the volatile memory.

12. The host device of claim 11, wherein the controller is further configured to repopulate the first address range in the first storage device's memory with data retrieved from the second storage device or from the host device.

13. The host device of claim 10, wherein the controller is further configured to, prior to sending the command to evict the cached data, store the cached data from the first address range of the first storage device's memory in the second storage device.

14. The host device of claim 13, wherein the controller is further configured to retrieve the cached data from the second storage device after exiting from a hibernation mode.

15. The host device of claim 14, wherein the controller is further configured to retrieve the cached data from the second storage device while the first storage device is idle.

16. The host device of claim 10, wherein the first storage device is a solid-state drive, and wherein the second storage device is a hard disk drive.

17. The host device of claim 16, wherein the solid-state drive and the hard disk drive are part of a hybrid hard drive.

18. The host device of claim 10, wherein the controller is further configured to work with the host devices BIOS to transition from a system standby mode to a hibernation mode.

19. The host device of claim 10, wherein the controller is further configured to perform compression on data to be stored in the hibernation file.
